(19) United States
(12) Patent Application Publication
(10) Pub. No.: US 2012/0117569 A1
(43) Pub. Date: May 10, 2012

(54) TASK AUTOMATION FOR UNFORMATTED TASKS DETERMINED BY USER INTERFACE PRESENTATION FORMATS

(75) Inventors: Alexis Fogel, Paris (FR); Guillaume Maron, Paris (FR); Jean Guillou, Paris (FR)

(73) Assignee: Kwift SAS, Puteaux (FR)

(21) Appl. No.: 13/113,990

(22) Filed: May 23, 2011

(30) Foreign Application Priority Data
Nov. 8, 2010 (FR) 10/04360
Nov. 8, 2010 (FR) 10/04361

(51) Int. Cl. G06F 9/46

(52) U.S. Cl. 718/102

(57) ABSTRACT

Methods and systems are provided for web page task automation. In one embodiment, the method comprises of the following steps: i) decomposing the high level task into a sequence of anthropomimetic subroutines, ii) decomposing each routine into a series of anthropomimetic actions or steps, for example stored as a unit shares of work, iii) generating computer code to interact with the content of the webpage, for each unit share of work, iv) executing the generated computer code by a web interface module, and transmitting the results of the execution of computer code, steps iii) and iv) being repeated until all steps of a subroutine have been executed, until the sequence of subroutines for a logical task have been achieved.

### CROSS-REFERENCE TO RELATED APPLICATIONS

This application is a Nonprovisional patent application claiming benefit under 35 USC §119(a) of the following applications, each naming Guillaume Maron, Jean Guillou, and Alexis Fogel:

French patent application Ser. No. 10/04360, filed Nov. 8, 2010, with the title “Méthode et systéme d′exécution informatisée de tâches sur Internet”, and

French patent application Ser. No. 10/04361, filed on Nov. 8, 2010, with the title “Procédé et systéme informatisée d′achat sur le web”.

Each provisional application cited above is hereby incorporated by reference for all purposes. The present disclosure also incorporates by reference, as is set forth in full in this document, for all purposes, the following commonly assigned applications/patents:

U.S. patent application Ser. No. ______ [Attorney Docket No. 93180-800064] filed of even date herewith and entitled “METHOD AND COMPUTER SYSTEM FOR PURCHASE ON THE WEB” naming Fogel, et al. (hereinafter “Fogel I”);

U.S. patent application Ser. No. ______ [Attorney Docket No. 93180-800065] filed of even date herewith and entitled “ANTHROPOMIMETIC ANALYSIS ENGINE FOR ANALYZING ONLINE FORMS TO DETERMINE USER VIEW-BASED WEB PAGE SEMANTICS” naming Fogel, et al. (hereinafter “Fogel III”);

U.S. patent application Ser. No. ______ [Attorney Docket No. 93180-800067] filed of even date herewith and entitled “METHOD AND SYSTEM FOR EXTRACTION AND ACCUMULATION OF SHOPPING DATA” naming Guillaume, et al. (hereinafter “Guillaume I”).

The respective disclosures of these applications/patents are incorporated herein by reference in their entirety for all purposes.

### FIELD OF THE INVENTION

The present invention relates to the field of task automation, wherein software is used to replace actions taken by users with respect to user interface tasks, and in particular to automating tasks wherein at least a part of the task is not defined ahead of time but is dictated by a presentation of a user interface element to a user where the presentation is not known entirely in advance.

### BACKGROUND

It has become quite popular to use network-based user interfaces. For example, a bank might provide its customers with access to a web-based interface, wherein the user uses a client system to connect over a network (such as the Internet) to a bank-operated server and browser software or a network-enabled app makes requests of the server and displays its responses. This can be interactive, as some of the responses can be in the form of interactive user interface elements such as a web page having fillable forms.

This approach has been becoming much more prevalent than vendors and other server operators providing fixed sets of software for the user to use for user interfaces, for a number of reasons. One reason for this approach is that the server operator can modify the website (i.e., the collection of software, data and hardware that receives requests for web pages and provides responses) fairly quickly and those modifications can take effect as soon as the next user requests the modified page.

Of course, one disadvantage of this is that the interfaces assume human user input. While that user interface might be well-laid out for human user input, it can be difficult to deal with when the user prefers to have some tasks automated. The format, layout and interface elements of a web page cannot always be determined or interacted with by automated processes with certainty. For example, just because one user visited a website (i.e., directed his/her/its web client to the URL associated with that website) and found a login page that says “Please log in here: →” does not mean that the next user might not see a login page that says “You can only access resources if you provide your username and password” because the website operator chose to modify their login page. This makes it difficult to automate the interaction with such websites.

Each web site operator might have its own implementation of an authentication process, and other processes, so it is difficult to automate the interaction. Automation is useful and users often prefer that. One example of automation is “auto-completion”. As an example, where a webpage has a set of form fields, the form fields have internal labels, one of the labels is “First Name” and the user had previously input “Renee” as their first name on a previous web page having that same form field with the same internal label, a browser or other web client with an auto-completion field might react to the user's input of “Re” with automatically filling in the form with “Renee” and saving the user some typing effort.

Some automation can be of an entire process, wherein user interaction is not needed. For example, a user might want to have a website visited and information copied from there, without user intervention.

As is well-known, browsers typically request pages that are formatted according to HTML (Hypertext Markup Language) or XML (Extensible Markup Language). While the format of those pages is certainly readable by humans, it is not intuitive and in normal operation, the browser will “render” the HTML page into a presentation that is designed to be viewed and interacted with by human users. Some XML is configured so that the reader or consumer of the XML page is a computer or automated process, for the most part HTML pages are designed with the assumption that, at least in part, the page will be presented to a human and be interacted with by a human, where the interaction occurs with a presentation displayed on a client device of the user.

In recent years, the Internet and especially the Web (the collection of HTML and similarly formatted, possibly interlinked set of documents that are typically accessed using a browser or app or similar tool, over a network or storage element), has become an important media, present in the daily life of a majority of people. This media can access a large number of virtual services, from any multimedia device with a screen, a hardware interface and an Internet connection and capable of running Internet browser software, e.g., a computer, a touch pad or a mobile phone.

There are presently websites for banking, shopping, travel planning and the like. Some are simply readable pages with information for the user, but others include interactive elements requiring input or actions by the users. For example, a banking site might have a static page listing current rates and terms for offerings, whereas another page might have interactive elements allowing for gathering information from the user to allow for performing certain tasks, such as checking account balances, or retrieving invoices, or validating purchases, and so on.

These services often require user authentication, requiring entering of a username and a password to allow access to the customer account for each service, including personal and confidential data: for example for ISPs, telephone, energy, banking sites, e-mail or online purchases. This leads to every Internet user managing a number of customer accounts, with different settings stored for each account.

Management by users of all these varying modes of operation to accomplish tasks on the various websites, especially where tied to a client account, is rather complex. In addition, this task management is a potential source of security risk due to personal and confidential data being maintained and being submitted for accomplishing the various transactions.

There is therefore a need for a reliable, simple and secure system or methods that allows users to have tasks automated, such as tasks in conjunction with web services, which are optionally related to an account.

### BRIEF SUMMARY

In various embodiments of a task automation system using aspects of the present invention, tasks are considered from the user's perspective rather than a preprogrammed perspective or a code perspective, i.e., from an anthropomimetic perspective. As an example of an anthropomimetic perspective, if the program code in a webpage has action A1 followed by action B1 followed by action C1, but when the page is rendered the user would see and interpret the page such that action B1 is followed by A1 is followed by C1, then an automation system might automate a task that automatically does actions in the user-perceived order (i.e., B1, A1, then C1) rather than in the order of appearance in the program (i.e., A1, B1, C1).

In one embodiment, task automation comprises of the following steps: i) decomposing the high level task into a sequence of anthropomimetic subroutines, ii) decomposing each routine into a series of anthropomimetic actions or steps, for example stored as a unit shares of work, iii) generating computer code to interact with the content of the webpage, for each unit share of work, iv) executing the generated computer code by a web interface module, and transmitting the results of the execution of computer code, steps iii) and iv) being repeated until all steps of a subroutine have been executed, until the sequence of subroutines for a logical task have been achieved.

An automation engine is capable of executing some tasks that have been defined manually and knows what routines to do to perform those tasks. A database or other data structure is available to users for automating these tasks. The automation is done in a way that the servers do not object to the automation occurring.

In another embodiment, a computerized system is provided for components implementing the method described above.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a simplified block diagram of one embodiment of a networked, Internet client server system.

FIG. 2 illustrates steps of task automation.

FIG. 3 is a schematic view of one embodiment of components of a background crawling engine.

### DETAILED DESCRIPTION OF THE INVENTION

As explained herein, methods, systems and apparatus are provided that automate execution of tasks on web pages. To provide a good user experience, task automation should follow what a user would think is a logical order and logical groupings. For example, if the user of a shopping website expects to log in, select products to purchase, enter billing information and confirm a purchase order, an automation engine would follow that process, but each website operator could have a different set of steps.

While the web pages might be provided over one or more different types of networks, such as the Internet, and might be used in many different scenarios, many of the examples herein will be explained with reference to a specific use, that of a user interacting with web pages of a plurality of banking web sites, with user interactions including logging in, and retrieving bank balances or statements.

This might be, for example, an automated task that is run automatically each day for the user to collect bank balances and store them into a local database. The task might be triggered either automatically or manually, but can be done without needing a user interface—the user might just see the results. In the automation process, the task automation should follow what a user would think is a logical sequence to be more efficient, and prevent a website from blocking the automation engine's interactions.

Those skilled in the art will appreciate that logic used to automate retrieval of account balances from a plurality of web sites have many applications and that improvements inspired by one application have broad utility in diverse applications that employ techniques used to automate web page task execution.

Below, example hardware is described that might be used to implement aspects of the present invention, followed by a description of software elements.

### Network Client Server Overview

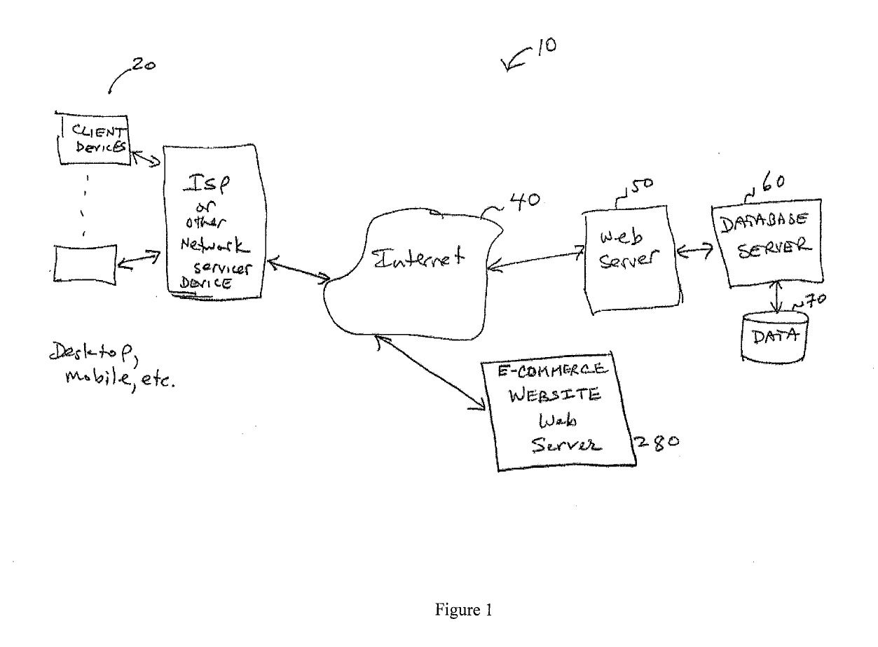

FIG. 1 is a simplified functional block diagram of an embodiment of an interaction system 10 in which embodiments of the automation engine described herein may be implemented. Interaction system 10 is shown and described in the context of web-based applications configured on client and server apparatus coupled to a network (in this example, the Internet 40). However, the system described here is used only as an example of one such system into which embodiments disclosed herein may be implemented. Various automation engine components described herein can also be implemented in other systems.

Interaction system 10 may include one or more clients 20. For example, a desktop web browser client 20 may be coupled to Internet 40 via a network gateway. In one embodiment, the network gateway can be provided by Internet service provider (ISP) hardware 80 coupled to Internet 40. In one embodiment, the network protocol used by clients is a TCP/IP based protocol, such as HTTP. These clients can then communicate with web servers and other destination devices coupled to Internet 40.

An e-commerce web server 80, hosting an e-commerce website, can also be coupled to Internet 40. E-commerce web server 80 is often connected to the internet via an ISP. Client 20 can communicate with e-commerce web server 80 via its connectivity to Internet 40. E-commerce web server 80 can be one or more computer servers, load-balanced to provide scalability and fail-over capabilities to clients accessing it.

A web server 50 can also be coupled to Internet 40. Web server 50 is often connected to the internet via an ISP. Client 20 can communicate with web server 50 via its connectivity to Internet 40. Web server 50 can be configured to provide a network interface to program logic and information accessible via a database server 60. Web server 50 can be one or more computer servers, load-balanced to provide scalability and fail-over capabilities to clients accessing it.

In one embodiment, web server 50 houses parts of the program logic that implements the task automation system described herein. For example, it might allow for downloading of software components, e.g., client-side plug-ins and other applications required for the systems described herein, and synching data between the clients running such a system and associated server components.

Web server 50 in turn can communicate with database server 60 that can be configured to access data 70. Database server 60 and data 70 can also comprise a set of servers, load-balanced to meet scalability and fail-over requirements of systems they provide data to. They may reside on web server 50 or on physically separate servers. Database server 60 can be configured to facilitate the retrieval of data 70. For example, database server 60 can retrieve data for the task automation engine described herein and forward it to clients communicating with web server 50. Alternatively, it may retrieve transactional data for the associated merchant websites hosted by web server 50 and forward those transactions to the requesting clients.

One of the clients 20 can include a desktop personal computer, workstation, laptop, personal digital assistant (PDA), cell phone, or any WAP-enabled device or any other computing device capable of interfacing directly or indirectly to Internet 40. Web client 20 might typically run a network interface application, which can be, for example, a browsing program such as Microsoft's Internet Explorer™, Netscape Navigator™ browser, Mozilla's Firefox™ browser, Opera's browser, Google's Chrome™ browser, Apple's Safari™ browser and/or a WAP-enabled browser executing on a cell phone, PDA, other wireless device, or the like. The network interface application can allow a user of web client 20 to access, process and view information and documents available to it from servers in the system, such as web server 50. The automation engine can run without any interaction from the user.

Web client 20 also typically includes one or more user interface devices, such as a keyboard, a mouse, touch screen, pen or the like, for interacting with a graphical user interface (GUI) provided by the browser on a display (e.g., monitor screen, LCD display, etc.), in conjunction with pages, forms and other information provided by servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, web client 20 and all of its components are operator configurable using an application including computer code run using a central processing unit such as an Intel Pentium™ processor, an AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of the servers over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on a client or server or compiled to execute on a client or server.

### Task Automation Overview

This disclosure provides methods and systems that help automate anthropomimetic tasks on the internet, where anthropomimetic refers to the logical behavior of a human being. A task can also be construed as a functional unit of work that needs to be done to execute a higher level user function (e.g., recovery of bank balances, recovery or payment of bills, creation of user accounts, recovery of contract documents, etc.). By automating such functional user tasks, an internet user's web experience is greatly simplified.

One useful case for task automation is aggregation of information from various websites. For example, account balances can be retrieved for the user from all of her bank accounts without the user having to navigate through the myriad of steps required to retrieve such balances from a host of banking websites. In such a case, automation of the task “recovering bank balances” may require execution of the following sequence of routines: test whether a user is already logged into the banking site, perhaps disconnect the user, login the user, retrieve summary of the accounts to recover the balances of bank accounts, and run such a sequence of routines per bank website.

In some aspects, task automation is achieved by breaking functional tasks into smaller units of routines to be executed sequentially in order to achieve the higher level functional task (e.g., in order to retrieve a bank balance, the subroutines to be executed may be (i) login and (ii) retrieve bank account balances summary page). The routines are then broken down into a sequence of steps required to perform each routine (e.g., to login for example, the required steps may encompass (i) provide login name, (ii) provide password, and (iii) execute “authenticate” button). In one aspect, the automation system then generates code for the steps required to execute each routine, thereby facilitating the automation of the functional task. In one embodiment, the generated code can be stored in a database for later use and re-use for other tasks that may require the same step. In another embodiment, the steps or unit shares of work are stored in a database to be later retrieved as the steps needed for the execution of a routine.

In one embodiment, task automation comprises of the following steps: i) decomposing the high level task into a sequence of anthropomimetic subroutines, ii) decomposing each routine into a series of anthropomimetic actions or steps, for example stored as a unit shares of work, iii) generating computer code to interact with the content of the webpage, for each unit share of work, iv) executing the generated computer code by a web interface module, and transmitting the results of the execution of computer code, steps iii) and iv) being repeated until all steps of a subroutine have been executed, until the sequence of subroutines for a logical task have been achieved.

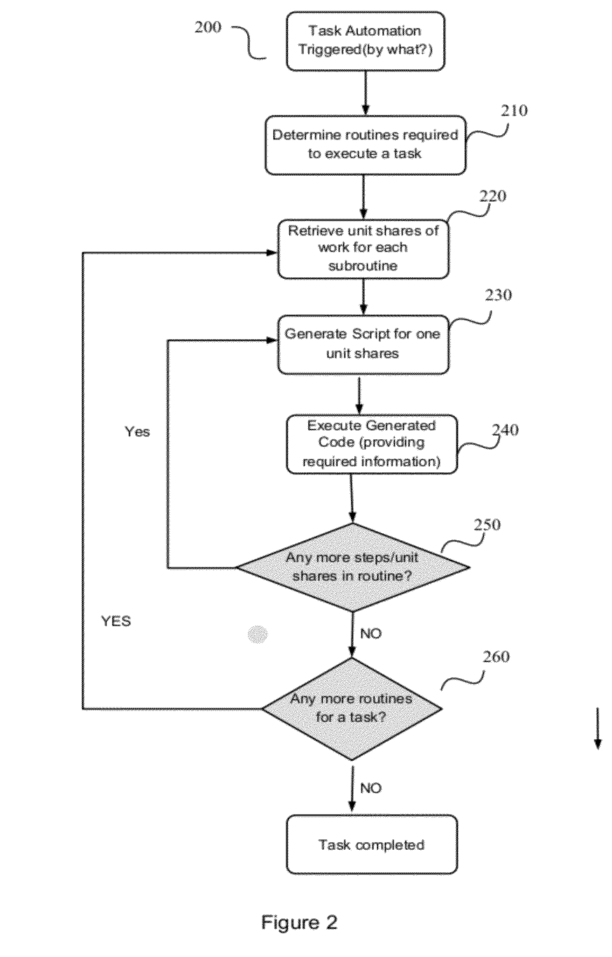

FIG. 2 illustrates steps of task automation. In step 200, a task automation is triggered for a user. Step 210 determines the routines required to be executed to accomplish the initiated task. Then the steps or unit shares of work required to execute a routine are retrieved from a database at step 220. At step 230, the script or code is generated for the one of the retrieved steps in the sequence of steps, which then is executed in step 240.

At step 250, the system will check to see if there are any more steps to be executed for the routine. If yes, then the flow will be redirected to step 230 for code to be generated for this step of the routine and then executed by step 240. If no additional steps remain for a routine, the system at step 260 will check to see if there are other routines to be executed for this task to be completed. If yes, then the flow will be directed to step 220 to retrieve the steps or unit shares of work required for executing the new routine. If no other routines are to be executed to accomplish the task then the task will be deemed completed.

One skilled in the art will appreciate that FIG. 2 represents one sequence of steps for task automation, and that the steps may vary considerably without deviating from the scope of this disclosure. For example, steps 230-240 may be executed only once for all steps of a routine or may be executed one time for each step or unit share in a routine. Similarly, steps 220-240 may be executed once for all routines for a task or may be individually executed per routine of a task.

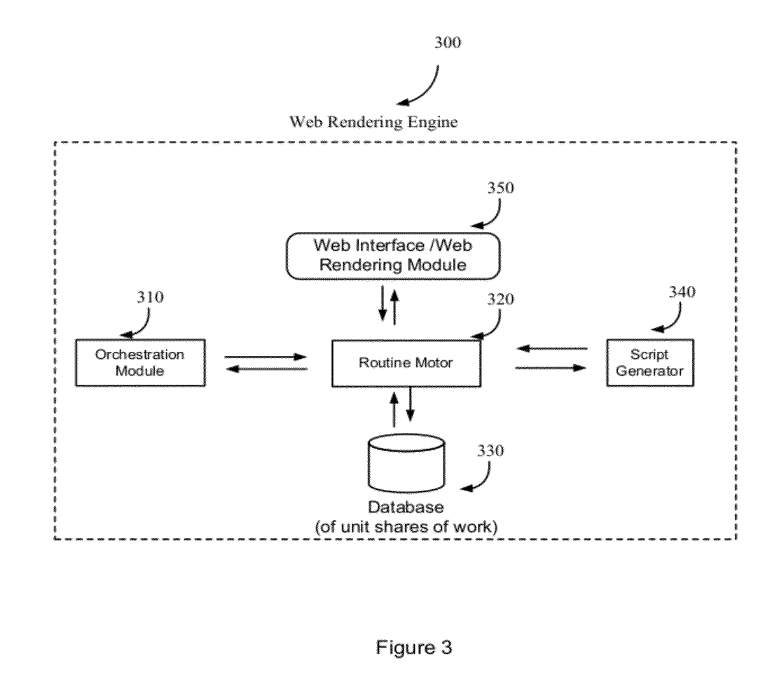

FIG. 3 is a schematic view of one embodiment of components/modules of a background crawling engine. A background crawling engine navigates websites on behalf of the user in the same way a user would do so manually, in other words, anthropomimetically. Background crawling engine 300 might include an orchestration module 310, a routine engine 320, database 330 (that stores details of routines), a script generator 340, and a web interface module 350. In one aspect, the orchestration module 310 passes information about the sequence of routines to be executed for a task to routine engine 320. Routine engine 320 retrieves steps required to be executed to accomplish a routine from database 330. Routine engine 320 then sends the steps over to script generator 340, which then generates the code which is executed by web rendering module 350.

In some aspects, orchestration module 310 coordinates the execution of the overall functional task on behalf of a user (e.g., collect bank account balances from various websites). Orchestration module defines the sequence of routines required to accomplish a task. In one embodiment, the decomposing of the sequence of routines required to automate a user task is done ahead of time. In another embodiment, the definitions of routine sequence per task may be cached or stored in a database for efficiency and reuse. This may be especially true where a user has already executed the same task using the automation engine. In other aspects, the stored definitions may be shared for other users of the system, who want to execute a task for which the routines if have already been identified.

In one embodiment, the orchestration module 310 submits sequential routines to be executed to routine engine 320 for further processing. Routine engine 320 may receive all routines required for one task or multiple tasks in one request or may receive them in chunks for efficiency purposes. The routine engine 320 then may retrieve the steps required for each routine from routines database 330. Database 330 in one aspect maintains a list of steps (and associated information) or unit shares of work (work unit, or work item) that needs to be performed for each routine for each website. Advantageously, some unit shares of work may be applied to other routines and to routines on other websites. This may help in re-use of definitions of steps required for executing a routine. In one aspect, the steps required for a routine may be shared for other users wanting to execute the same task.

In one embodiment, once routine engine 320 retrieves unit shares of work from database 330, it passes the information, one unit share at a time, over to script generator 340. Script generator 340 then generates the code required to execute the unit share of work and passes it to web interface module 350 for execution of the code on behalf of the user. In another embodiment, routine engine 320 passes all the tasks for a routine over to script generator 340 which then codes all steps and passes them onto web rendering module 350 for execution. In one embodiment, the generated code is written in the Javascript™ language.

In some aspects, web rendering module 350 will require consumer data to fill in the fields of the webpage prior to executing it. Thus, web interface module 350 often requires input from the website user, on whose behalf the task is being executed, or from a database of consumer information. Such an input step may be performed before or during the execution of the sequence of routines. In addition, the input step can be performed directly by the user or may be executed by the automation engine, such as via script generator 340 accessing a user database encrypted with the appropriate means known to those skilled in the art for this purpose. The various embodiments of soliciting input from users can be based on user discretion, and the relationship between the degree of automation and preservation of confidentiality desired by a user (e.g., maintained in user preferences database).

Script generator 340 may interact with a consumer personal information database in order to provide the information required to execute a task. A consumer personal information database is described in Fogel I and III. The web interface module 350 may retrieve data from the consumer database in order to populate fields prior to execution of the scripted code.

Routine engine 320 may repeat the process described above for each routine it needs to execute in order to accomplish the task(s) on behalf of a user. Alternatively, it may take all routines and retrieve information from unit shares database 330 for all routines and pass that information on to the script generator 340. One skilled in the art can appreciate that the modularity or the breakdown of components implementing the logic for task automation may vary greatly (e.g., using only one component or distributing the programming logic across many programming modules, breaking the steps executed by each component as needed, etc.), without deviating from the logic of the automation steps.

In some aspects, the architecture and design of the automation system facilitates maintenance and updating of dynamic data without having to recompile the entire program. For example, a cache may be updated when a new task is evaluated to determine the sequence of routines. Alternatively, this task-to-routines mapping information may be stored in a database, thus requiring only the database to be updated when a task is added or updated for its sequence of routines information. Also, the database component 230 of unit shares may be the only thing that needs to be updated where the steps of a routine are being analyzed. In another embodiment, adding a new task, along with its sequence of routines requires updating of the program and recompilation. One skilled in the art can appreciate various optimization techniques without deviating from the conceptual logic of the task automation system.

A task might be triggered automatically or manually using the automation interface. A task might be broken down into the same routines for each website. For example, routines might be broken down into routines per task such as, for every bank website, retrieving accounts balances involves routines to verify whether a prior user is logged in, disconnect the prior user if so, connect the current user, navigate to the accounts webpage, retrieve balances.

Each implementation of a routine for a site can be stored into an XML file. The construction of this file (stored into database 330) might be a manual process done in advance. Fogel III teaches a discovery engine that could be used to pre-create such file, with human validation possibly done ahead of time. The structure of the XML files might be atomic action, with arguments. For example, to describe the filling of a field, the XML DB might describe the type of the action (filling element), the target of the action (generally an XPath path that points to the element to be filled into the webpage, for example, input[id=“user login”], and the value to put in, either literally, or as an argument (the user's login in this case).

Then, the script generator 340 will take all those details and create a Javascript™ code sequence to be executed.

According to one embodiment, the web interface module performs a set of steps. The first step is to download or otherwise obtain an HTML page and its associated files, such as embedded images, scripts, styles, etc. The next step is to recreate the structure of the web page from the HTML source code, execute any scripts, which may cause changes to the structure and content of the web page, manage AJAX requests and the like from the web page, etc. Then the web interface module allows execution of any valid JavaScript code, thereby enabling access to the structure and content of the web page via the execution of the JavaScript code, and allows simulation of user actions via the execution of JavaScript code. The web interface module can also provide access to the images that make up the web page, manage cookies and other state variables, manage secure connections, and potentially allowing the download of electronic file formats. In effect, the web interface module sets up a page as if the user were going to manually interact with it.

While the use of a web interface module provides an opening for hidden user operation, the logic allows for the method to run fully automated, without user intervention during execution. It also ensures optimal interaction with the elements of the web, especially AJAX requests (for English Asynchronous JavaScript and XML), ensuring the proper conduct of the execution of a task. The use of logic anthropomimetism can meet the security controls that are in place on some websites, including speed enforcement actions and the achievement of a given sequence of actions when such websites might block intrusive scripts.

In one embodiment, the interface module is a web rendering engine, also known as HTML rendering engine. For example, the skilled person can use the engine Webkit. This engine is advantageously coupled with a library that can handle secure connections, such as OpenSSL.

One skilled in the art can appreciate that the functionality of the web rendering engine described above, using AJAX and Javascript, can be replaced without difficulty by any equivalent language known to those skilled in the art, depending on the evolution of programming languages, web pages, and/or web renderers.

According to one aspect, the sequence of steps or actions determined for each routine to be executed, for each task on a Web site is defined in a database of unit shares. In one embodiment, the database unit shares of work is represented in XML (Extensible Markup for English Language). Thus, based on the precise operation of each Web site, listing the actions' unit shares of work corresponds to a routine for a particular web site, and it can be easily updated to add Web sites or take into account changes in sites, without questioning the logic of method execution.

A computer system might be configured to handle tasks on a website wherein the computer system includes at least one multimedia device with a screen, a hardware interface device connected to the multimedia device, a network connection, a processor computer with electronic storage having stored thereon a computer program on a storage medium readable by the multimedia device. The computer system might further include module coordinator that defines a sequence of anthropomimetism routines for each task in a plurality of tasks, a database of unit shares, including, routines parsed into a sequence of routines to perform actions and then submits each action unit to a script generator that returns a computer code to perform the unitary action on the Web site.

In one embodiment, a computer system executing tasks on a website is provided. This system implements the computerized method for task automation previously described. Such a system includes at least one multimedia device with a screen, a hardware interface connected to said multimedia device, means of connection to the internet, a computer processor in electronic link with a computer program stored on a storage medium readable by said multimedia device, said computer program comprising instructions that when executed by the processor implement the method of the invention. In one embodiment, the multimedia device is a computer or mobile phone.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A computer-implemented method for maintaining a database of unit shares of work to automate a web routine for task automation, the method comprising:
determining, from a database storing therein unit shares of work, operations for one or more web pages for the website;
determining a task to be performed by the one or more web pages from the analysis, wherein at least a part of the task requires context of other elements of the one or more web pages;
breaking the task into routines of the task;
breaking the routines into units shares of work for the routines; and
executing the unit shares of work from a database of web routine automation.

2. A computer-implemented method for task automation, the method comprising:
receiving a task to be automated;
decomposing the task into a sequence of anthropomimetic subroutines;
decomposing each routine into a sequence of anthropomimetic actions or steps;
for each anthropomimetic subroutine identified;
for each anthropomimetic action identified;
generating computer code to interact with the content of a webpage for each anthropomimetic action identified; and
executing the generated code.

3. The method of claim 2, wherein the step of executing the generated code further comprises receiving consumer information.

4. The method of claim 3, wherein the step of receiving consumer information is performed before or during the execution of the generated code for anthropomimetic routines.

5. The method of claim 3, wherein the receiving of consumer information is performed directly by the user or returned from a secure database.

6. The method of claim 2, further comprising:
downloading, to a user device, an HTML page and in-line associated files;
recreating a structure of a web page from source code of the HTML page; and
if a web page script is associated with the HTML page, executing the web page script and updating structure and content of the HTML page.

7. The method of claim 2, wherein an anthropomimetism determining unit executes routines for a plurality of websites defined in a web database of unit shares.
